(19) United States
(12) Patent Application Publication
(10) Pub. No.: US 2009/0048861 A1
(43) Pub. Date: Feb. 19, 2009

(54) Retail center for designing and laser engraving simultaneously different sized products at varying locations on the products

(76) Inventor: Robert R. Lichtenheld, Phoenix, AZ (US)

Correspondence Address: TOD R NISSLE, PO BOX 55630, PHOENIX, AZ, 85078, US

(21) Appl. No.: 12/156,470

(22) Filed: May 30, 2008

Related U.S. Application Data
(60) Provisional application No. 60/932,377, filed on May 31, 2007.

(51) Int. Cl. G06Q 10/00

(52) U.S. Cl. 705/1

(57) ABSTRACT

A retail outlet for designing and producing laser engraved products.

This application claims priority based on provisional patent application Ser. No. 60/932,377, filed May 31, 2007.

This invention relates to laser engraving.

More particularly, the invention relates to a method and system for laser engraving simultaneously in a retail setting a variety of different products for a plurality of customers.

Laser engraving is widely known and utilized.

One setting in which laser engraving is utilized is to engrave products in a manufacturing plant.

Another setting in which laser engraving is utilized is a system in which customers input information which is utilized by a machine to engrave and dispense a particular product. Once the machine receives the necessary input information from a customer, the machine automatically laser engraves and dispenses the product.

Still a further setting in which laser engraving is utilized is when a place of business provides a product and laser engraves the product in accordance with verbal instructions or written instructions provided by a customer visiting the place of business.

None of the above systems, however, appear tailored in a retail setting to serving simultaneously a plurality of customers, to laser engraving simultaneously products at different in-house locations, to engraving simultaneously a plurality of products of differing shape and dimension, and to engraving a product at different selected locations on the product.

Accordingly, it would desirable to provide an improved laser engraving process for engraving simultaneously a variety of products for different customers.

Therefore, it is a principal object of the invention to provide an improved laser engraving retail outlet.

Another object of the invention is to provide an improved laser engraving system that facilitates the simultaneous laser engraving of different products by manually positioning the products in separate laser engraving machines.

A further object of the invention is to provide an improved laser engraving retail outlet that facilitates the laser engraving of different products by providing for each different product a template defining how and where each product can be engraved.

These and other, further and more specific objects and advantages of the invention will be apparent to those of skill in the art from the following detailed description thereof, taken in conjunction with the drawings, in which:

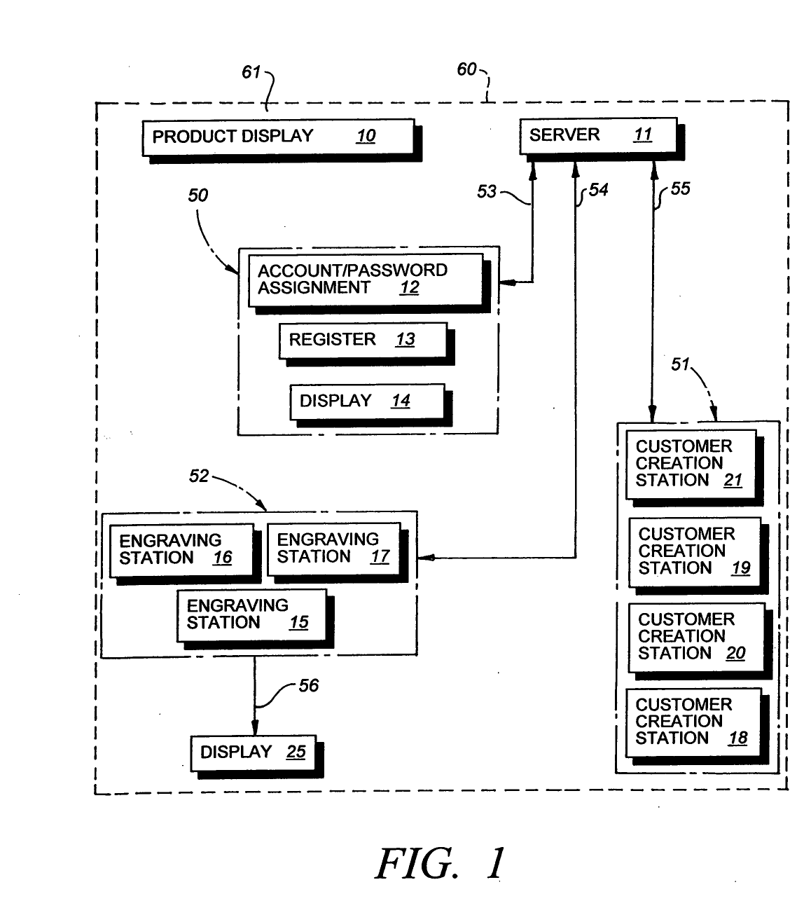

FIG. 1 is a block diagram illustrating a retail laser engraving system constructed in accordance with the invention;

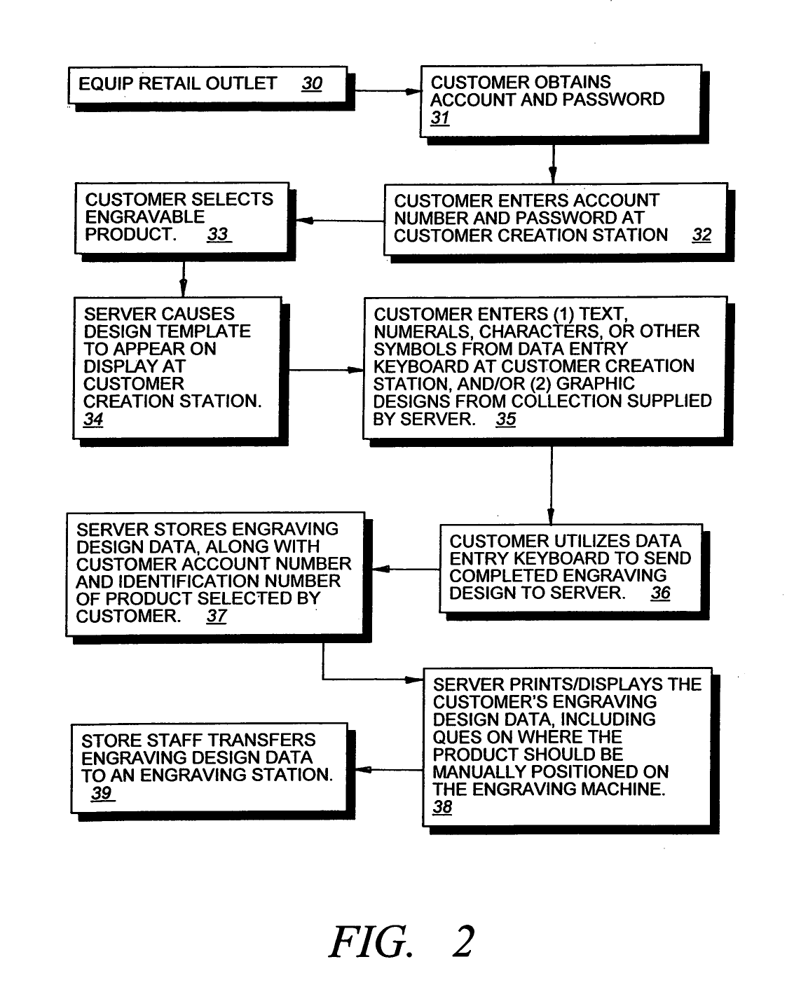

FIG. 2 is a block flow diagram further illustrating the retail laser engraving system of the invention; and,

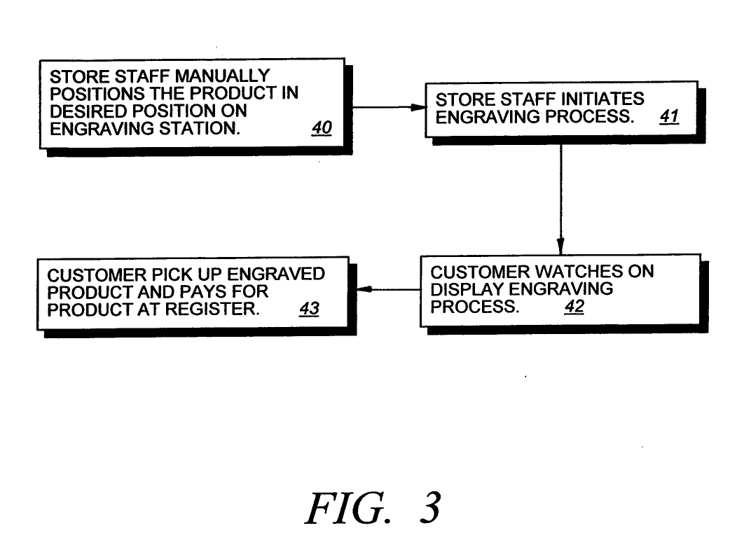

FIG. 3 is a block flow diagram further illustrating the retail laser engraving system of the invention.

Briefly, in accordance with the invention, I provide a retail outlet for designing and producing laser engraved products. The retail outlet includes a building structure with a floor; a display in a first selected area on the floor of different engravable products; a server in the building including a plurality of customer selectable symbols, a plurality of customer selectable graphics, a plurality of customer selectable engravable products, data entry apparatus, and a display; a data entry apparatus in communication with the server to assign an account and password to a customer; and, a population of account and password accessible customer creation stations in a second selected area on the floor and in communication with the server, each of the customer creation stations including a display, and a data entry apparatus. The data entry apparatus of the customer creation station enters in the sever the account number and the password to access the server; defines a customer engraved product by selecting one of the selectable engravable products, selecting at least one of the symbols and of the graphics to be engraved on the selected one of the selectable engravable products, and transmits to the server the customer engraved product. The retail outlet also includes a population of engraving stations in a third selected area on the floor and in communication with the server, each of the engraving stations including a system for manually positioning on the station in at least two different positions at least one of the engravable products; and, a customer display for customers to witness the engraving of one of the engravable products. The data entry system of the server transmits data defining the customer engraved product to at least one of the engraving stations. The server produces instructions for manually positioning the selected one of the selectable engravable products on at least one of the laser engraving machines to be engraved with the selected symbol and graphics.

Turning now the drawings, which depict the presently preferred embodiments of the invention for the purpose of illustration thereof, and not by way of limitation of the invention, and in which like characters refer to corresponding elements throughout the several views, FIG. 1 illustrates a retail outlet including a building 60 with a floor 61. Located on floor 61 are product display 10, server 11, staff control area 50, customer creation station population area 51, engraving station population area 52, and display 25. As used herein, a product display 10, server 11, etc. is located on floor 61 if it is setting on and contacting floor 61 or if it is supported above and spaced apart from floor 61.

When a customer enters building 60, a staff member in control area 50 assigns 12 an account and a server password to the customer. The control area 50 includes display 14. Display 14 includes a flat screen, CRT, or other display; a keyboard or other data entry system for communicating with server 11; and, a printer. Server 11 comprises a computer. Control area 50 also includes a register 13 to accept payment from a customer. Control area 50 can include a computer to interface with server 11.

Customer creation station area 51 includes a population 18 to 21 of customer creation stations. Engraving station area 52 includes a population of engraving stations.

Each customer creation station 18 to 21 includes a keyboard or other data entry to communicate with server 11 and includes a flat screen, CRT, or other display. A station 18 to 21 can includes a computer to interface with server 11.

In addition to maintaining customer account and password records, server 11 receives orders from each customer creation station and notifies staff of the same by printing out an order, by showing an order summary on display 14, or by some other notification on display 14 or otherwise in control area 50 or building 60. Server 11 includes a data base of engravable products provided in the retail outlet and from which a customer can select a product, includes a data base of graphic designs from which a customer can select one or more designs, and includes a template associated with each of the engravable products. The template appears on the display of a customer creation station 18 to 21 after a customer selects the associated product. The template indicates areas on the product where on the product selected designs and symbols can be placed. The customer enters selected designs and/or symbols in the desired area(s) of the product. The template also indicates the size of the area in which a selected design or symbol can be placed. The template can permit the size of the design or symbol to be adjusted to fit in the desired area of a product.

After a customer's order is completed, the customer uses the keyboard at the customer creation station 18 to 21 to forward the order to server 11. When prompted by a store staff member in the control area 50, server 11 can send the necessary data in a customer's order to an engraving station 15 to 17 so that the product selected by the customer can be engraved at the engraving station. Or, the server 11 can automatically forward the necessary data to an engraving station.

Each engraving station in area 52 permits products of different size and shape to be placed on the engraving station 15 to 17 to be engraved. One way of accomplishing this is to have fixed stop surfaces that are normal to each other and accept one corner of a product. This permits the corner of each product to be placed at a known location on the engraving station 15 to 17, which enables the engraving station to determine—from data defining the size and shape of the product—the location on the machine of each point on a surface to be engraved at the station. Any other means can be utilized by a station 15 to 17 to enable the station to determine the location of a surface area on a product manually placed on a station 15 to 17 to be engraved.

Display 25 comprises a television, computer flat screen, computer CRT, etc. When a product is being engraved at a station 15 to 17, the engraving on the product of customer selected symbols and graphics (designs) can be observed by a customer on display 25. Display 25 shows the actual engraving taking place or shows a simulation of the engraving that is taking place.

An example of the system of the invention is set forth in more detail in FIGS. 2 and 3, and includes the initial step 30 of equipping a retail outlet 30 with the equipment illustrated in FIG. 1. When a customer enters retail outlet 60, the customer obtains 31 from a staff member in control area 50 an account and password.

The customer selects a customer creation station 21 and enters 32 his or her account number and password to access server 11.

The customer then utilizes the keyboard at the customer creation station 21 to examine on the display at station 21 engravable products offered by the retail outlet, and then selects 33 one of the products.

After the customer selects an engravable product, the server 11 causes a template to appear on the display at station 21. The display indicates the areas on the selected product that can be engraved. The customer examines graphic designs (pictures, drawings, photographs, artistic renditions, etc.) that are stored in a data base in server 11 and, if the customer desires, selects a design and inserts the design in the template. The customer can similarly select any letter(s), number(s), or other symbols on his or her keyboard and enter the same in the template by typing the associated keys on the keyboard.

The customer completes the engraving design by entering all of the desired symbols and graphic designs in the template and then sends 36 to server 11 data defining the completed design.

Server 11 stores 37 the data defining the engraving design, along with the customer account number and the identification number of the product selected by the customer.

The server 11 shows 38 on display 14 the order to alert a staff member, or, prints the order on the printer comprises a part of display 14, or otherwise alerts the staff member that a customer's order is ready for a product to be engraved. The order displayed on display 14 by server 11 includes directions and/or pictures of how the product should be oriented or placed on the engraving station 15.

A store staff member, utilizing the data entry system in control area 50, transfers 39 the engraving design data to an engraving station 15.

The store staff member, following the prompts and directions provided on display 14 (or on a print out), obtains the appropriate product, properly orients the product, and places and positions 40 the product on engraving station 15.

The store staff member, either by operating station 15 or by utilizing the data entry system associated with display 14, initiates 41 the engraving process.

While engraving station 15 engraves the customer's product, the customer watches 47 display 25. Display 25 shows the actual engraving taking place, or provides a simulation of the engraving taking place or of the product after it is engraved.

Finally, the customer picks up the engraved product and pays 43 for the product at register 13.

Having described the presently preferred embodiments and best mode of the invention in such terms as to enable those of skill in the art to understand and practice the invention, I claim:

1. A retail outlet for designing and producing laser engraved products, including
(a) a building structure with a floor;
(b) a display in a first selected area on said floor of different engravable products;
(c) a server in said building including
(i) a plurality of customer selectable symbols,
(ii) a plurality of customer selectable graphics,
(iii) a plurality of customer selectable engravable products,
(iv) data entry apparatus, and
(v) a display;
(d) a data entry system in communication with said server to assign an account and password to a customer;
(e) a population of account and password accessible customer creation stations in a second selected area on said floor and in communication with said server, each of said customer creation stations including
(i) a display, and
(ii) data entry for
entering said account number and said password to access said server,
defining a customer engraved product by
selecting one of said selectable engravable products,
selecting at least one of said symbols and of said graphics to be engraved on said selected one of said selectable engravable products, and
transmitting to said server said customer engraved product;
(f) a population of engraving stations in a third selected area on said floor and in communication with said server, each of said stations including a system for manually positioning on said station in at least two different positions at least one of said engravable products; and,
(g) a customer display for customers to witness the engraving of one of said engravable products;
said data entry system of said servor transmitting data defining said customer engraved product to at least one of said engraving stations,
said servor producing instructions for manually positioning said selected one of said selectable engravable products on at least one of said laser engraving machines to be engraved with said selected symbol and graphics.
